(19) United States
(12) Patent Application Publication
(10) Pub. No.: US 2026/0300413 A1
(43) Pub. Date: Oct. 1, 2026

(54) NON-DETERMINISTIC PRODUCT SEARCH EVALUATION

(71) Applicant: Salesforce, Inc., San Francisco, CA (US)

(72) Inventors: Nikhil KAPRE, Bengaluru (IN); Boris ALEKSANDROVSKY, San Francisco, CA (US); Akshay MEHOTRA, Bengaluru (IN)

(21) Appl. No.: 19/091,498

(22) Filed: Mar. 26, 2025

(51) Int. Cl. G06F 16/953; G06Q 30/014

(52) U.S. Cl. CPC G06F 16/953; G06Q 30/014

(57) ABSTRACT

Systems, devices, and techniques are disclosed for non-deterministic product search evaluation. A catalog including items may be received. Categories, attributes for the categories, and values for the attributes, may be determined from the items in the catalog. A search query that was also input to a non-deterministic search system may be received. Categories that are responsive to the search query may be determined. Search results that were generated by the non-deterministic search system in response to the search query and including items from the catalog may be received. Categories of the items of the search results may be determined.

A query score for the non-deterministic search system may be determined based on the attributes and values for the categories that were determined to be responsive to the search query and the categories of the items of the search results.

### BACKGROUND

Evaluating non-deterministic search systems, such as large language model (LLM) agent search systems, may be challenging due to the non-determinism. A non-deterministic search system may give different outputs for the same input, and the different outputs may both be correct, making it difficult to determine the accuracy of the non-deterministic search systems' search results. This may result in quality metrics for non-deterministic search systems being inconsistent. LLM based judges may be used to determine quality metrics for a non-deterministic search system. However, LLM judges may also be non-deterministic, which may compound with the non-deterministic output of the non-deterministic search system and further increase the inconsistency of the quality metrics. LLM judges may operate using text prompts which may be hard to design an appropriately. Lacking consistent quality metrics for a non-deterministic search system may make it difficult to determine when the non-deterministic search system is not functioning properly and to improve its performance.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for non-deterministic product search evaluation according to an implementation of the disclosed subject matter.

FIG. 2 shows an example arrangement suitable for non-deterministic product search evaluation according to an implementation of the disclosed subject matter.

FIG. 3 shows an example arrangement suitable for non-deterministic product search evaluation according to an implementation of the disclosed subject matter.

FIG. 4 shows an example arrangement suitable for non-deterministic product search evaluation according to an implementation of the disclosed subject matter.

FIG. 5 shows an example procedure suitable for non-deterministic product search evaluation according to an implementation of the disclosed subject matter.

FIG. 6 shows an example procedure suitable for non-deterministic product search evaluation according to an implementation of the disclosed subject matter.

FIG. 7 shows a computer according to an implementation of the disclosed subject matter.

FIG. 8 shows a network configuration according to an implementation of the disclosed subject matter.

### DETAILED DESCRIPTION

Techniques disclosed herein enable non-deterministic product search evaluation, which may allow for output of non-deterministic search systems to be evaluated in a consistent manner so that poorly functioning non-deterministic search systems may be detected, disabled, and improved. A catalog including items may be received. Categories, attributes for the categories, and values for the attributes, may be determined from the items in the catalog. A search query input to a non-deterministic search system may be received. Categories that are responsive to the search query may be determined. Search results generated by the non-deterministic search system in response to the search query and including items from the catalog may be received. The categories of the items of the search results may be determined. A query score for the non-deterministic search system may be determined based on the attributes and values for the categories that were determined to be responsive to the search query and the categories of the items of the search results. The query score may be determined to be below a threshold. The non-deterministic search system may be disabled.

A catalog including items may be received. The catalog may be any suitable catalog of any suitable items and may be received from any suitable source. The catalog may be, for example, a product catalog for an online store, and the items may be, for example, products sold by the online store.

Categories, attributes for the categories, and values for the attributes, may be determined from the items in the catalog. The catalog may be pre-processed to extract categories, attributes, and values for the attributes from the items in the catalog. The categories for the catalog may already be included in the catalog, which may, for example, include a category as part of the description of each item in the catalog, or may be determined using any suitable form of cluster embedding to cluster the items in the catalog and assign categories to the clusters. The k categories determined for a catalog may be categories C₁ to Cₖ. The categories may then be mapped to attributes for the items in the categories. The attributes may be features or properties of the items and may or may not be listed in the catalog, for example, as part of a description of or listing for the item. The mapping of categories to attributes may be done using a pretrained model or knowledge graph to determine typical attributes for a category based on the items from the catalog that are in the category. The use of a pretrained model may be non-deterministic, so the determined mapping may be stored in a suitable cache storage for future use. The mapping of a category to attributes may be, for example, Cₖ→{Aₖᵢ}. The catalog may also include global attributes G which may be attributes that every item in the catalog has. The global attributes for items that are products in a product catalog may be, for example, price and shipping costs. The items in the catalog may be assigned attributes based on the categories C₁ to Cₖ to which the items belong and the global attributes, and attribute values for the item's attributes, including global attributes, may be determined. These values may be determined using a constrained generation task performed by, for example, a small language model (SLM), with an input prompt for each item that includes the <Item, Attribute> pair and outputs an <Attribute, Value> pair. The use of an SLM may be non-deterministic, so the determined values may be stored in a suitable cache storage for future use.

A search query input to a non-deterministic search system may be received. The received search query may be a search query Q that was also input into a non-deterministic search system, such as an LLM, to search for items for the catalog that are responsive to the search query. The search query may be, for example, a natural language search query input by a user to search, for example, the product catalog of an online store.

Categories that are responsive to the search query may be determined. The categories may be determined based on the search query Q from among the categories C₁ to Cₖ for the catalog. The categories may be determined using predictions generated as the output of a classification task performed by pretrained embedding model or using retrieval augmented generation (RAG) with a suitable LLM. The categories may be determined according to Q, {Cₖ} →C_{q1}, C_{q2}, . . . The use of an LLM with RAG or pretrained embedding model may be non-deterministic, so the determined categories responsive to the search query Q may be stored in a suitable cache storage for future use. Attributes for the categories determined to be responsive to the search query, including global attributes, may be received by being read from the cache storage where they were stored after being determined from the catalog, such that a set of attributes A_{qi} are retrieved for each category C_{qi} For each of the categories determined to be responsive to the search query, the values X_{qi} of the attributes for that category, and optionally, importance weights W_{qi} for the attributes, may be determined such that Q, {A_{qi}}→{X_{qi}, W_{qi}}. The values for the attributes may be determined using a constrained generation task, such as an SLM given an input of <Query, Attribute> and with an output of <Attribute Value, Weigh Value>. The weighting scheme may be any suitable weighting scheme, including simple weighting schemes such as binary relevance weighting or a limited set of weighting levels. The use of an SLM may be non-deterministic, so the determined values may be stored in a suitable cache storage for future use.

Search results generated by the non-deterministic search system in response to the search query and including items from the catalog may be received. The non-deterministic search system may have responded to the search query Q with search results of a set of items {Pᵢ}. For example, if items in the catalog are products being sold, the non-deterministic search system may have returned a set of products to the user that the non-deterministic search system determined to be most responsive to the search query input by the user.

The categories of the items of the search results may be determined. The items from the catalog in the search results may belong to categories from the catalog. The categories to which the items belong may be determined in any suitable manner, including, for example, based on the categories to which the items were previously determined to belong based on the description of each item in the catalog or the use of a suitable form of cluster embedding.

A query score for the non-deterministic search system may be determined based on the attributes and values for the categories that were determined to be responsive to the search query and the categories of the items of the search results. The items {Pᵢ} in the search results may be scored on a per-category basis. The value Vᵢ corresponding to an attribute A_{qi} for an item P from the set of items {Pᵢ} may be received through a lookup in the cache storage. A score for each of the categories determined for the items of the search results may be determined according to S_{Pi}=Σₖ1(Xₓ∈PVᵢ)·Wₖᵢ. In some implementations, fuzzy matching may be used in place of exact matching. A query score, which may be a metric for the quality of the search results determined by the non-deterministic search system based on the search query, may be determined according to QueryScore_{Q}=NDCG(S_{Pi}), where NDCG may be Normalized Discounted Cumulative Gain. The determined QueryScore_{Q} may be aggregated over a number of different search queries input to the non-deterministic search system. Additionally, a recall metric may be determined by counting all of the items in the catalog that have matching categories and attributes to the in the set of items from the search results.

The query score may be determined to be below a threshold. A threshold score for the non-deterministic search system may be set to any suitable value. Query scores generated for the non-deterministic search system may be compared to this threshold score at any suitable time and in any suitable manner. For example, the non-deterministic search system may be scored every 15 minutes using a set of test search queries. The query scores for search results generated for each of the search queries may be compared to the threshold score independently or the query scores for a non-deterministic search system may be aggregated across any number of test search queries and the aggregate may be compared to the threshold score.

The non-deterministic search system may be disabled. If at any point a query score, either for an individual search query or an aggregate, for the non-deterministic search system falls below the threshold score, the non-deterministic search system may be disabled. The query score being below the threshold score may indicate the non-deterministic search system is not performing properly and should not be available to users. Any other suitable actions may also be taken, including, for example, notifications being sent using any suitable form of electronic communication to any suitable party indicating that the non-deterministic search system may need to be examined and fixed.

A feedback loop may be used to improve the accuracy of the non-deterministic search system based on the query scores. When the query score falls below a second threshold score that may be higher than the threshold score that results in the non-deterministic search system being disabled, the non-deterministic search system may have its mapping between item categories and item attributes, its lookup data updated with further enriched mapping data, and additional grounding of enriched data in LLMs of the non-deterministic search system.

When the non-deterministic search system is used to search the same catalog in the future based on additional search queries, data from the cached storage may be used instead of repeating non-deterministic steps wherever possible when evaluating the search results generated by the non-deterministic search system. For example, the determined mapping of categories to attributes for the catalog may be retrieved from the cache storage instead of being re-mapped using the pretrained model or knowledge graph and the determined values for attributes may be retrieved from the cache storage instead of being redetermined using the SLM.

Data from the cache storage that was stored based on the search query, such as determined categories responsive to a search query, may also be reused when a new search query is the same as, or similar enough to, the search query that resulted in the data being stored in the cache storage. This may reduce non-determinism in the evaluation of the non-deterministic search system while still allowing the evaluation to be flexible enough to properly handle situations where the non-deterministic search system provides different sets of results to separate inputs of the same, or similar, search queries, and the different sets of results should all be considered correct. For example, the non-deterministic search system may be tested by using the same search query as input to the non-deterministic search system multiple times.

The use of smaller pre-trained models, knowledge graphs, and database lookups into the cache storage may be more efficient, and reduce computational overhead, when compared to using LLM-based judges to evaluate the non-deterministic search system. Pre-processing steps, such as pre-processing of the catalog, may only need to be performed once, allowing the computational cost to be amortized over repeated use of the data that results from pre-processing. Storing attribute values and query categories in the cache storage may also increase efficiency.

Evaluation of the non-deterministic search system may be used in the re-ranking of search results generated by the non-deterministic search system. For example, a non-deterministic search system may use an LLM to modify keywords in a search query submitted by a user based on the LLM's determinations about the semantics of the search query. The modified search query may then be used with a boolean search engine to generate a number of search results, for example, 20 to 40 results. Re-ranking may be used to select some number, for example, three, of the best search results from among the 20 to 40 search results generated by the boolean search engine based on the search query as modified by the LLM. The re-ranking may use the evaluation of the non-deterministic search system to generate a query score for each of the search results, may then present to the user the number, for example, three, search results with the highest query scores.

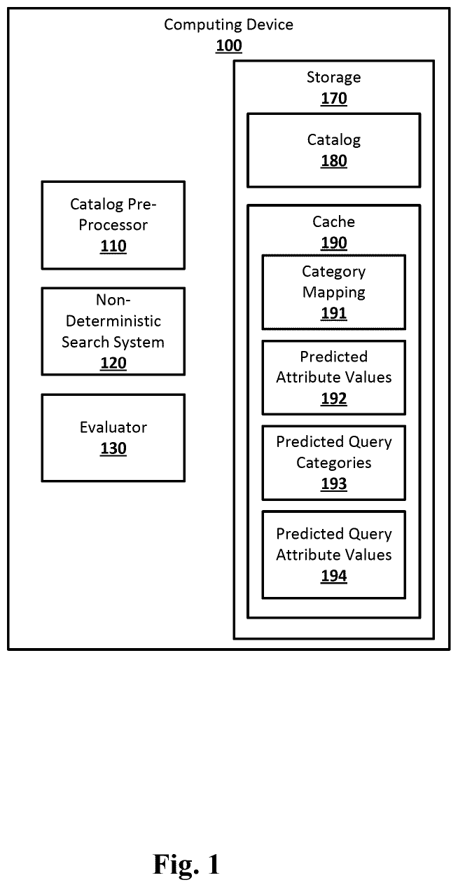

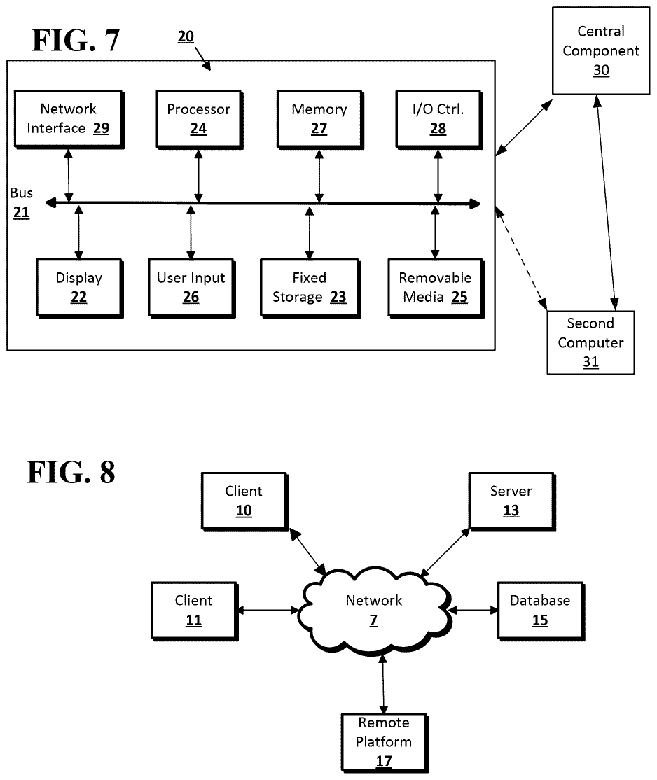

FIG. 1 shows an example system suitable for non-deterministic product search evaluation according to an implementation of the disclosed subject matter. A computing device 100 may be any suitable computing device, such as, for example, a computer 20 as described in FIG. 7, or component thereof, for implementing non-deterministic product search evaluation. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs). For example, the computing device 100 may be, or be part of, a cloud computing sever system that may be a multi-tenanted server system.

The computing device 100 may include a catalog pre-processor 110. The catalog pre-processor 110 may be any suitable combination of hardware and software of the computing device 100 for implementing a pre-processor for processing a catalog of items to determine categories for the items, map the categories to attributes, and determine values for the attributes. The catalog pre-processor 110 may, for example, receive a catalog of items such as catalog 180, extract categories from the catalog, use a pretrained model or knowledge graph to determine attributes for the categories, and use an SLM to determine attribute values for the attributes including attributes for the categories and global attributes for the catalog.

The computing device 100 may include a non-deterministic search system 120. The non-deterministic search system 120 may be any suitable combination of hardware and software of the computing device 100 for implementing a search system that may be able to search a catalog, such as the catalog 180, using at least one component, such an LLM, that causes the output of non-deterministic search system 120 to be non-deterministic. The non-deterministic search system 120 may receive search queries input by users, search the catalog, and return items from the catalog as search results based on the search queries. The use of an LLM or other non-deterministic component by the non-deterministic search system 120 may result in the non-deterministic search system 120 returning different search results for the same search query even if the items in the catalog have not changed.

The computing device 100 may include a non-deterministic search system 120. The non-deterministic search system 120 may be any suitable combination of hardware and software of the computing device 100 for implementing an evaluator system for scoring the search results output by the non-deterministic search system 120. The evaluator 130 may, for example, receive search results from the non-deterministic search system 120 and the search query for those search results, predict query categories that would be responsive to the search query using a pretrained embedding model or an LLM with RAG or by using previously predicted query categories for the search query, determine attributes for the predicted categories, predict attribute values for the determined attributes using an SLM or by using previously predicted attribute values, score the search results generated by the non-deterministic search system 120 on an item and category basis, generate a query score for the search results from the scores generated on an item and category basis, and generate a recall metric value based on counting items in the search results in categories that match predicted categories as true positives. The evaluator may also perform remediating actions when the query scores for the non-deterministic search system 120 fall below a threshold, including, for example, disabling the non-deterministic search system 120 and improving the accuracy of the non-deterministic search system 120 by improving its mapping between item categories and item attributes, updating its lookup data further enriched mapping data, and performing additional grounding of enriched data in LLMs of the non-deterministic search system 120.

The storage 170 may be any suitable combination of hardware and software for storing data. The storage 170 may include any suitable combination of volatile and non-volatile storage hardware and may include components of the computing device 100 and hardware accessible to the computing device 100, for example, through wired and wireless direct or network connections. The storage 170 may store the catalog 180 and a cache 190. The cache 190 may store outputs generated by non-deterministic systems, such as SLMs, used by the catalog pre-processor 110 and the evaluator 130, including, category mapping 191, predicted attribute values 192, predicted query categories 193, and predicted query attribute values 194.

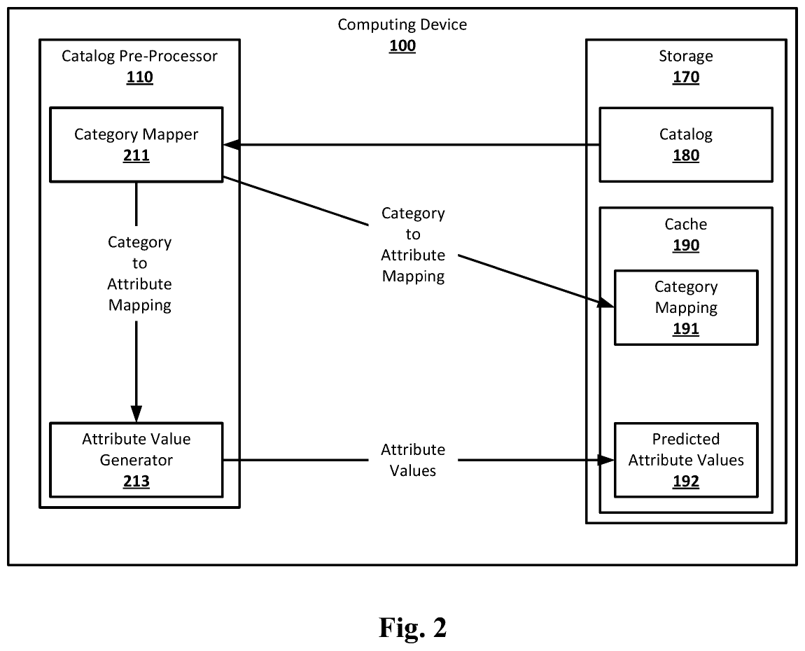

FIG. 2 shows an example arrangement suitable for non-deterministic product search evaluation according to an implementation of the disclosed subject matter. The catalog pre-processor 110 may receive the catalog 180 from the storage 170. The catalog 180 may be a catalog of items, such as products from an on-line store. The catalog pre-processor 110 may not have previously processed the catalog 180. A category mapper 211 of the catalog pre-processor 110 may extract categories for the items in the catalog 180. The categories for the catalog 180 may already be included in the catalog 180, which may, for example, include a category as part of the description of each item in the catalog 180, or the category mapper 211 may determine the categories using any suitable form of cluster embedding to cluster the items in the catalog 180 and assign categories to the clusters. The k categories determined for the catalog 180 may be categories C₁ to Cₖ.

The catalog mapper 211 may then map the categories from the catalog 180 to attributes for the items in the categories. The attributes may be features or properties of the items and may or may not be listed in the catalog 180, for example, as part of a description of or listing for the item. The catalog mapper 211 may use a pretrained model or knowledge graph to determine typical attributes for a category based on the items from the catalog 180 that are in the category. The use of a pretrained model may be non-deterministic, so the determined category to attribute mapping may be stored as the category mapping 191 in the cache 190 for future use. The mapping of a category to attributes may be, for example, Cₖ→{Aₖᵢ}. The catalog 180 may also include global attributes G. The global attributes for items that are products in a product catalog may be, for example, price and shipping costs.

The category to attribute mapping may be received at an attribute value generator 213 of the catalog pre-processor 110. The attribute value generator 213 may determine, or predict, attribute values for attributes, including global attributes, of the items in the catalog 180, with an item's attributes including global attributes and the attributes that were mapped by the category mapper 211 to the category, from, for example categories C₁ to Cₖ, to which the item belongs.

The attribute value generator 213 may determine attribute values using a constrained generation task performed by, for example, a small language model (SLM), with an input prompt for each item that includes the <Item, Attribute> pair and outputs an <Attribute, Value> pair. The use of an SLM may be non-deterministic, so the determined attribute values may be stored in the cache 190 as predicted attribute values 192 for future use.

The catalog pre-processor 110 may be used to process any number of catalogs, storing data for the pre-processed catalogs in the cache 190. A catalog may only need to be processed by the catalog pre-processor 110 once.

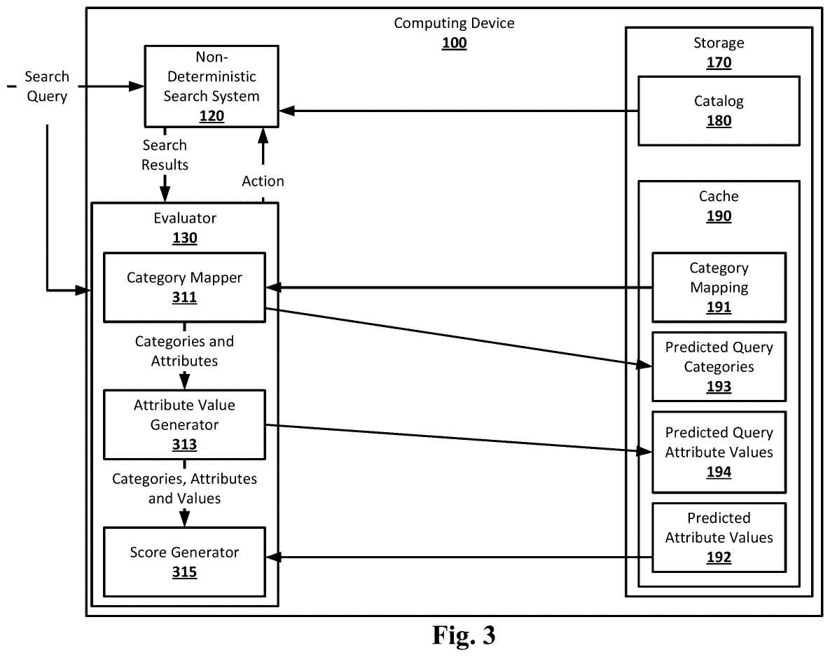

FIG. 3 shows an example arrangement suitable for non-deterministic product search evaluation according to an implementation of the disclosed subject matter. A search query may be received at the non-deterministic search system 120. The search query may be, for example, a natural language search query received from a user who wants to search items of the catalog 180. The non-deterministic search system 120 may search the catalog 180 to generate search results, which may be, for example, a list of items from the catalog 180 that the non-deterministic search system 120 determines are responsive to the search query.

The evaluator 130 may receive the search query input to the non-deterministic search system 120. The received search query may be a search query Q. A category mapper 311 of the evaluator 130 may determine, or predict, categories that are responsive to the search query. The categories may be determined based on the search query Q from among the categories C₁ to Cₖ for the catalog 180 that are stored as part of the category mapping 191. The category mapper 311 may determine the categories using predictions generated as the output of a classification task performed by pretrained embedding model or using retrieval augmented generation (RAG) with a suitable LLM. The categories may be determined according to Q, {Cₖ}→C_{q1}, C_{q2}, . . . The use of an LLM with RAG or pretrained embedding model may be non-deterministic, so the determined categories responsive to the search query Q may be stored in as the predicted query categories 193 in the cache 190 for future use. The category mapper 311 may be the same as, or may be separate from, the category mapper 211.

The category mapper 311 may then determine attributes for the categories determined to be responsive to the search query by reading them from the category mapping 191 in the cache 190 where they were stored after being determined from the catalog 180, such that a set of attributes A_{qi} are retrieved for each category C_{qi} For each of the categories determined to be responsive to the search query, the values X_{qi} of the attributes for that category, and optionally, importance weights W_{qi} for the attributes, may be determined such that Q, {A_{qi}}→{X_{qi}, W_{qi}}.

An attribute value generator 313 of the evaluator 130 may receive the categories and attributes from the category mapper 311. The attribute value generator 313 may determine values and weights for the attributes using a constrained generation task, such as an SLM given an input of <Query, Attribute> and with an output of <Attribute Value, Weight Value>. The weighting scheme may be any suitable weighting scheme, including simple weighting schemes such as binary relevance weighting or a limited set of weighting levels. The use of an SLM may be non-deterministic, so the determined values and weights may be stored as the predicted query attribute values 194 in the cache 190.

The search results generated by the non-deterministic search system 120 in response to the search query Q and including items from the catalog 180 may be received by the evaluator 130. The non-deterministic search system 120 may have responded to the search query Q with search results of a set of items {Pᵢ}. For example, if items in the catalog 180 are products being sold, the non-deterministic search system 120 may have returned a set of products to the user that the non-deterministic search system 120 determined to be most responsive to the search query input by the user.

The categories of the items of the search results may be determined. The items from the catalog 180 in the search results may belong to categories from the catalog 180. The categories to which the items belong may be determined in any suitable manner by the evaluator 130.

The score generator 315 may generate a query score for the non-deterministic search system 120 based on the attributes and values for the categories that were determined to be responsive to the search query and the categories of the items of the search results. The items {Pᵢ} in the search results may be scored on a per-category basis. The value Vᵢ corresponding to an attribute A_{qi} for an item P from the set of items {Pᵢ} may be received through a lookup of the predicted attribute values 192 in the cache 190. A score for each of the categories determined for the items of the search results may be determined according to S_{Pi}=Σₖ1(Xₖ∈PVᵢ)·Wₖᵢ. In some implementations, fuzzy matching may be used in place of exact matching. The score generator 315 may generate the query score, which may be a metric for the quality of the search results determined by the non-deterministic search system 120 based on the search query, according to QueryScore_{Q}=NDCG(S_{Pi}), where NDCG may be Normalized Discounted Cumulative Gain. The determined QueryScore_{Q} may be aggregated over a number of different search queries input to the non-deterministic search system 120. Additionally, a recall metric may be determined by counting all of the items in the catalog that have matching categories and attributes to the in the set of items from the search results.

The evaluator 130 may compare the query score generated by the score generator 315 to a threshold score. If the score is determined to be below the threshold, the evaluator 130 may take, or initiate the taking of, remediating action. For example, the evaluator 130 may disable the non-deterministic search system 120. The evaluator 130 may also improve the accuracy of the non-deterministic search system 120, for example, by updating its mapping between item categories and item attributes, updating its lookup data with further enriched mapping data, and performing additional grounding of enriched data in LLMs of the non-deterministic search system 120.

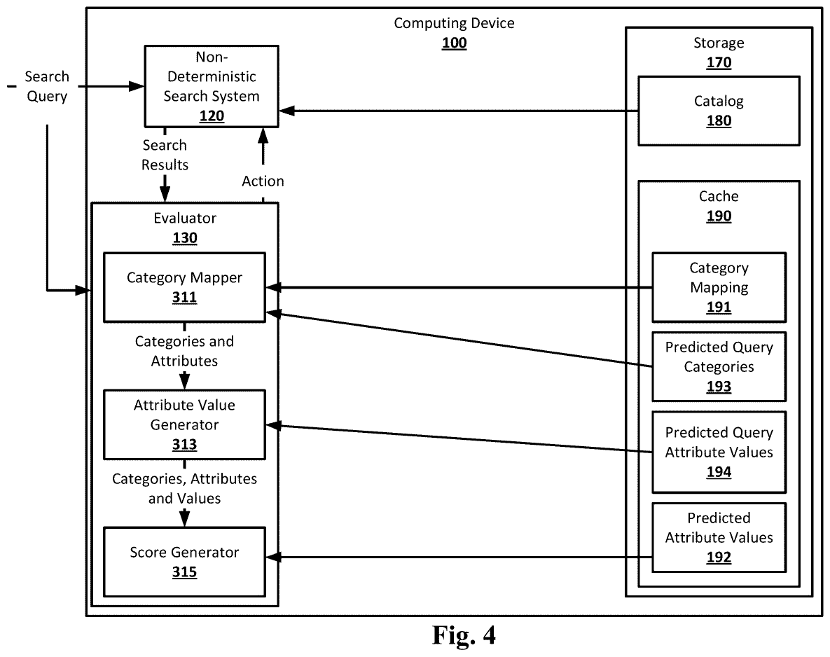

FIG. 4 shows an example arrangement suitable for non-deterministic product search evaluation according to an implementation of the disclosed subject matter. A search query may be received at the non-deterministic search system 120. The search query may be, for example, a search query that has been previously received at the non-deterministic search system 120 and may have resulted in the generation and storage in the cache 190 of the predicted query categories 193 and the predicted query attribute values 194. For example, the same search query may be input to the non-deterministic search system 120 multiple different times intentionally as part of testing of the non-deterministic search system 120. The non-deterministic search system 120 may search the catalog 180 to generate search results, which may be the same as or may differ from the search results the non-deterministic search system 120 generated when the search query was used as input previously.

The evaluator 130 may receive the search query input to the non-deterministic search system 120. The received search query may be a search query Q. The category mapper 311 of the evaluator 130 may receive the predicted query categories 193, which may be the query categories that are responsive to the search query Q, from the cache 190, where they have been stored the first time the search query Q was input to the non-deterministic search system 120.

The category mapper 311 may then determine attributes for the categories determined to be responsive to the search query by reading them from the category mapping 191 in the cache 190 where they were stored after being determined from the catalog 180, such that a set of attributes A_{qi} are retrieved for each category C_{qi}

For each of the categories determined to be responsive to the search query, the values X_{qi} of the attributes for that category, and optionally, importance weights W_{qi} for the attributes, may be determined such that Q, {A_{qi}}→{X_{qi}, W_{qi}}. The attribute value generator 313 may receive the categories and attributes from the category mapper 311. The attribute value generator 313 may receive the predicted query attribute values 194, which may be the attribute values for the attributes of the predicted categories 193, and weights, from the cache 190 where they may have been stored the first time the search query Q was input to the non-deterministic search system 120.

The search results generated by the non-deterministic search system 120 in response to the search query Q and including items from the catalog 180 may be received by the evaluator 130. The non-deterministic search system 120 may have responded to the search query Q with search results of a set of items {Xᵢ}, which may be different from, or the same as, the set of items {Pᵢ}. For example, if items in the catalog 180 are products being sold, the non-deterministic search system 120 may have returned a set of products to the user that the non-deterministic search system 120 determined to be most responsive to the search query input by the user.

The categories of the items of the search results may be determined. The items from the catalog 180 in the search results may belong to categories from the catalog 180. The categories to which the items belong may be determined in any suitable manner by the evaluator 130.

The score generator 315 may generate a query score for the non-deterministic search system 120 based on the attributes and values for the categories that were determined to be responsive to the search query and the categories of the items of the search results. The items {Xᵢ} in the search results may be scored on a per-category basis. The value Vᵢ corresponding to an attribute A_{qi} for an item X from the set of items {Xᵢ} may be received through a lookup of the predicted attribute values 192 in the cache 190. A score for each of the categories determined for the items of the search results may be determined according to S_{Pi}=Σₖ1(Xₖ∈XVᵢ)·Wₖᵢ. In some implementations, fuzzy matching may be used in place of exact matching. The score generator 315 may generate the query score, which may be a metric for the quality of the search results determined by the non-deterministic search system 120 based on the search query, according to QueryScore_{Q}=NDCG(S_{Pi}), where NDCG may be Normalized Discounted Cumulative Gain. The determined QueryScore_{Q} may be aggregated over a number of different search queries input to the non-deterministic search system 120. Additionally, a recall metric may be determined by counting all of the items in the catalog that have matching categories and attributes to the in the set of items from the search results.

The evaluator 130 may compare the query score generated by the score generator 315 to a threshold score. If the score is determined to be below the threshold, the evaluator 130 may take, or initiate the taking of, remediating action. For example, the evaluator 130 may disable the non-deterministic search system 120. The evaluator 130 may also improve the accuracy of the non-deterministic search system 120, for example, by updating its mapping between item categories and item attributes, updating its lookup data with further enriched mapping data, and performing additional grounding of enriched data in LLMs of the non-deterministic search system 120.

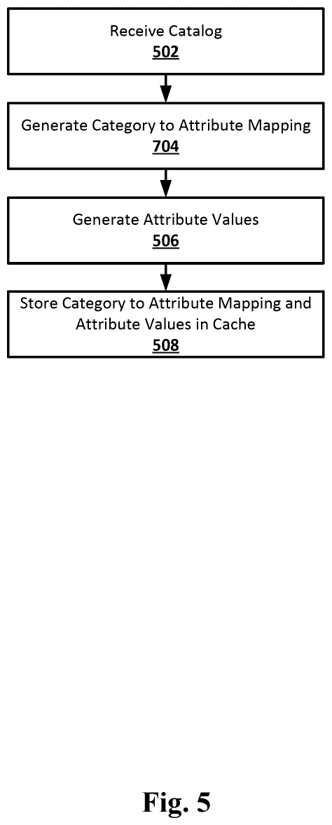

FIG. 5 shows an example procedure suitable for non-deterministic product search evaluation according to an implementation of the disclosed subject matter. At 502, a catalog may be received. For example, the catalog pre-processor 110 may receive the catalog 180. The catalog 180 may be a catalog of items, which may be, for example, products sold by an online store. The catalog pre-processor 110 may not have previously received the catalog 180.

At 504, a category to attribute mapping may be generated. For example, the category mapper 211 of the catalog pre-processor 110 may extract categories for the items in the catalog 180. The categories for the catalog 180 may already be included in the catalog 180, which may, for example, include a category as part of the description of each item in the catalog 180, or the category mapper 211 may determine the categories using any suitable form of cluster embedding to cluster the items in the catalog 180 and assign categories to the clusters. The k categories determined for the catalog 180 may be categories C₁ to Cₖ. The catalog mapper 211 may then map the categories from the catalog 180 to attributes for the items in the categories. The attributes may be features or properties of the items and may or may not be listed in the catalog 180, for example, as part of a description of or listing for the item. The catalog mapper 211 may use a pretrained model or knowledge graph to determine typical attributes for a category based on the items from the catalog 180 that are in the category. The use of a pretrained model may be non-deterministic, so the determined category to attribute mapping may be stored as the category mapping 191 in the cache 190 for future use. The mapping of a category to attributes may be, for example, Cₖ→{Aₖᵢ}. The catalog 180 may also include global attributes G. The global attributes for items that are products in a product catalog may be, for example, price and shipping costs.

At 506, attribute values may be generated. For example, the attribute value generator 213 of the catalog pre-processor 110 may determine, or predict, attribute values for attributes, including global attributes, of the items in the catalog 180, with an item's attributes including global attributes and the attributes that were mapped by the category mapper 211 to the category, from, for example categories C₁ to Cₖ, to which the item belongs. The attribute value generator 213 may determine attribute values using a constrained generation task performed by, for example, a small language model (SLM), with an input prompt for each item that includes the <Item, Attribute> pair and outputs an <Attribute, Value> pair. The use of an SLM may be non-deterministic, so the determined attribute values may be stored in the cache 190 as predicted attribute values 192 for future use.

At 508, the category to attribute mapping and attribute values may be stored in a cache. For example, the use of a pretrained model by the category mapper 211 may be non-deterministic, so the determined category to attribute mapping may be stored as the category mapping 191 in the cache 190 for future use, and the use of an SLM by the attribute value generator 213 may be non-deterministic, so the determined values may be stored as the predicted query attribute values 194 in the cache 190.

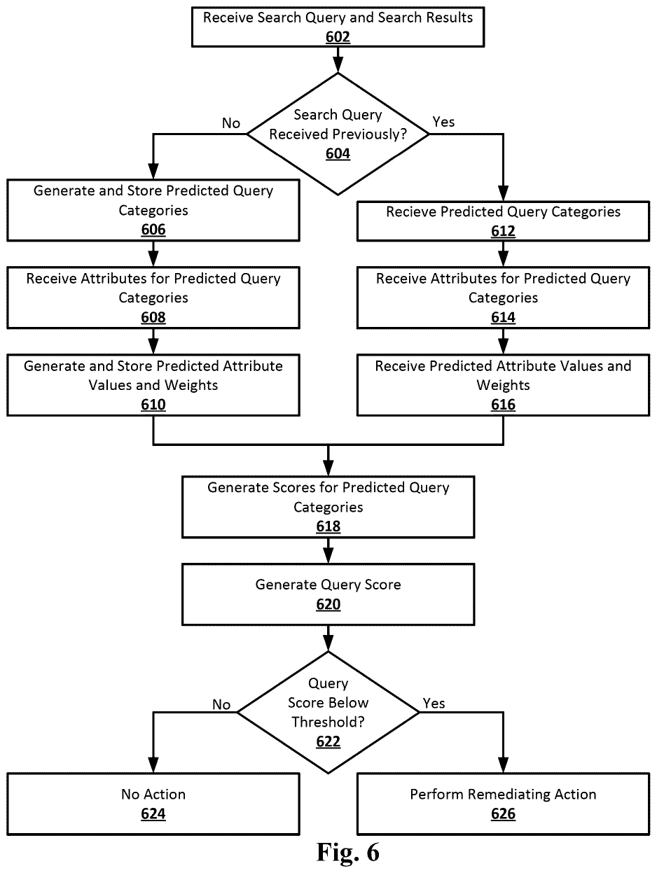

FIG. 6 shows an example procedure suitable for non-deterministic product search evaluation according to an implementation of the disclosed subject matter. At 602, a search query and search results may be received. For example, the evaluator 130 may receive a search query that was input to the non-deterministic search system 120 and the search results that were generated by the non-deterministic search system 120 in response to the search query. The search query may be, for example, a natural language search query.

At 604, if the search query has been previously received, flow may proceed to block 612. Otherwise, if the search query has not been previously received, flow may proceed to block 606. For example, the search query received by the evaluator 130 may be the same as a search query that had already been received at the evaluator 130. This may occur when, for example, a search query is deliberately re-used during testing of the non-deterministic search system 120.

At 606, predicted query categories may be generated and stored. For example, the search query may have been determined to have not been previously received by the evaluator 130, so there may be no data for the search query in the cache 190. The category mapper 311 of the evaluator 130 may determine, or predict, categories that are responsive to the search query. The categories may be determined based on the search query Q from among the categories C₁ to Cₖ for the catalog 180 that are stored as part of the category mapping 191. The category mapper 311 may determine the categories using predictions generated as the output of a classification task performed by pretrained embedding model or using retrieval augmented generation (RAG) with a suitable LLM. The categories may be determined according to Q, {Cₖ}→C_{q1}, C_{q2}, . . . The use of an LLM with RAG or pretrained embedding model may be non-deterministic, so the determined categories responsive to the search query Q may be stored in as the predicted query categories 193 in the cache 190 for future use.

At 608, attributes for the predicted categories may be received. For example, the category mapper 311 may determine attributes for the categories determined to be responsive to the search query by reading them from the category mapping 191 in the cache 190 where they were stored after being determined from the catalog 180, such that a set of attributes A_{qi} are retrieved for each category C_{qi} For each of the categories determined to be responsive to the search query, the values X_{qi} of the attributes for that category, and optionally, importance weights W_{qi} for the attributes, may be determined such that Q, {A_{qi}}→{X_{qi}, W_{qi}}.

At 610, predicted attribute values and weights may be stored and generated. For example, the attribute value generator 313 of the evaluator 130 may receive the categories and attributes from the category mapper 311. The attribute value generator 313 may determine values for the attributes using a constrained generation task, such as an SLM given an input of <Query, Attribute> and with an output of <Attribute Value, Weight Value>. The weighting scheme may be any suitable weighting scheme, including simple weighting schemes such as binary relevance weighting or a limited set of weighting levels. The use of an SLM may be non-deterministic, so the determined values may be stored as the predicted query attribute values 194 in the cache 190.

At 612, predicted query categories may be received. For example, the search query may have been previously received by the evaluator 130 and there may be data for the search query stored in the cache 190. The category mapper 311 of the evaluator 130 may receive the predicted query categories 193, which may be the query categories that are responsive to the search query Q, from the cache 190, where they have been stored the first time the search query Q was input to the non-deterministic search system 120.

At 614, attributes for the predicted categories may be received. For example, the category mapper 311 may determine attributes for the categories determined to be responsive to the search query by reading them from the category mapping 191 in the cache 190 where they were stored after being determined from the catalog 180, such that a set of attributes A_{qi} are retrieved for each category C_{qi} For each of the categories determined to be responsive to the search query, the values X_{qi} of the attributes for that category, and optionally, importance weights W_{qi} for the attributes, may be determined such that Q, {A_{qi}}×{X_{qi}, W_{qi}}.

At 616, predicted attribute values and weights may be received. For example, the attribute value generator 313 may receive the predicted query attribute values 194, which may be the attribute values for the attributes of the predicted categories 193, and weights, from the cache 190 where they may have been stored the first time the search query Q was input to the non-deterministic search system 120.

At 618, scores may be generated for the predicted query categories. For example, the score generator 315 may generate scores for the search results received from the non-deterministic search system 120 on a per-category basis. The items {Pᵢ} in the search results may be scored on a per-category basis. The value Vᵢ corresponding to an attribute A_{qi} for an item P from the set of items {Pᵢ} may be received through a lookup of the predicted attribute values 192 in the cache 190. A score for each of the categories determined for the items of the search results may be determined according to S_{Pi}=Σₖ1(Xₖ∈PVᵢ)·Wₖᵢ. In some implementations, fuzzy matching may be used in place of exact matching.

At 620, a query score may be generated. For example, the score generator 315 may generate a query score for the non-deterministic search system 120. The score generator 315 may generate the query score, which may be a metric for the quality of the search results determined by the non-deterministic search system 120 based on the search query, according to QueryScore_{Q}=NDCG(S_{Pi}), where NDCG may be Normalized Discounted Cumulative Gain.

The determined QueryScore_{Q} may be aggregated over a number of different search queries input to the non-deterministic search system 120. Additionally, the score generator 315 may generate a recall metric by counting all of the items in the catalog that have matching categories and attributes to the in the set of items from the search results. The query scores for multiple search queries input to the non-deterministic search system 120 may be aggregated into a query score for the non-deterministic search system 120.

At 622, if the query score is determined to be below a threshold score, flow may proceed to 626. Otherwise, flow may proceed to 624. For example, the query score for the non-deterministic search system 120 may be compared to a threshold score that may be set to any suitable value.

At 624, no action may be taken. For example, the query score may have been determined to not be below the threshold score. This may indicate that the non-deterministic search system 120 is functioning properly and remediating actions need to be taken.

At 626, a remediating action may be performed. For example, the query score may have been determined to be below a threshold. This may indicate that the non-deterministic search system 120 is not functioning properly and may be returning lower-quality search results. The evaluator 130, or any other suitable component of the computing device 100, may perform any suitable remediating actions on the non-deterministic search system 120. For example, the non-deterministic search system 120 may be temporarily disabled to prevent users from receiving lower-quality search results. The accuracy of the non-deterministic search system 120 may also be improved, for example, by updating its mapping between item categories and item attributes, updating its lookup data with further enriched mapping data, and performing additional grounding of enriched data in LLMs of the non-deterministic search system 120.

Implementations of the presently disclosed subject matter may be implemented in and used with a variety of component and network architectures. FIG. 7 is an example computer 20 suitable for implementing implementations of the presently disclosed subject matter. As discussed in further detail herein, the computer 20 may be a single computer in a network of multiple computers. As shown in FIG. 7, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 8.

Many other devices or components (not shown) may be connected in a similar manner (e.g., document scanners, digital cameras and so on). Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 27, fixed storage 23, removable media 25, or on a remote storage location.

FIG. 8 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving, at a computing device, a catalog comprising items;
determining, with the computing device, categories, attributes for the categories, and values for the attributes, from the items in the catalog;
receiving, with the computing device, a search query that was also input to a non-deterministic search system;
determining, with the computing device, categories that are responsive to the search query;
receiving, with the computing device, search results that were generated by the non-deterministic search system in response to the search query and comprising items from the catalog;
determining, with the computing device, categories of the items of the search results;
determining, with the computing device, a query score for the non-deterministic search system based on the attributes and values for the categories that were determined to be responsive to the search query and the categories of the items of the search results;
determining, with the computing device, that the query score is below a threshold; and
disabling, with the computing device, the non-deterministic search system.

2. The computer-implemented method of claim 1, further comprising determining a recall metric for the non-deterministic search system based on the categories that were determined to be responsive to the search query and the categories of the items of the search results.

3. The computer-implemented method of claim 1, wherein determining a query score for the non-deterministic search system based on the attributes and values for the categories that were determined to be responsive to the search query and the categories of the items of the search results further comprises determining values and weights for attributes of the categories of the items of the search results.

4. The computer-implemented method of claim 1, further comprising storing, in a cache storage, the categories, the attributes for the categories, the values for the attributes, the categories of the items of the search results, and values for attributes of the categories of the items in the search results.

5. The computer-implemented method of claim 1, further comprising:
updating a mapping of categories to attributes for the non-deterministic search system; and
enabling the non-deterministic search system.

6. The computer-implemented method of claim 1, further comprising:
receiving a second search query that was also input to a non-deterministic search system, wherein the second search query is the same as the search query;
determining categories that are responsive to the second search query by reading the categories that were responsive to the search query from a cache storage;
receiving second search results that were generated by the non-deterministic search system in response to the second search query and comprising items from the catalog;
determining categories of the items of the second search results;
determining a second query score for the non-deterministic search system based on the attributes and values for the categories that were determined to be responsive to the second search query and the categories of the items of the second search results;
determining that the second query score is below a threshold; and
disabling the non-deterministic search system.

7. The computer-implemented method of claim 1, wherein the non-deterministic search system comprises a large language model.

8. A computer-implemented system comprising:
one or more storage devices; and
a processor that receives catalog comprising items,
determines categories, attributes for the categories, and values for the attributes, from the items in the catalog,
receives a search query that was also input to a non-deterministic search system;
determines categories that are responsive to the search query,
receives search results that were generated by the non-deterministic search system in response to the search query and comprising items from the catalog,
determines categories of the items of the search results,
determines a query score for the non-deterministic search system based on the attributes and values for the categories that were determined to be responsive to the search query and the categories of the items of the search results,
determines that the query score is below a threshold, and
disables the non-deterministic search system.

9. The computer-implemented system of claim 8, wherein the processor further determines a recall metric for the non-deterministic search system based on the categories that were determined to be responsive to the search query and the categories of the items of the search results.

10. The computer-implemented system of claim 8, wherein the processor determines a query score for the non-deterministic search system based on the attributes and values for the categories that were determined to be responsive to the search query and the categories of the items of the search results by determining values and weights for attributes of the categories of the items of the search results.

11. The computer-implemented system of claim 8, wherein the processor further stores, in a cache storage, the categories, the attributes for the categories, the values for the attributes, the categories of the items of the search results, and values for attributes of the categories of the items in the search results.

12. The computer-implemented system of claim 8, wherein the processor further updates a mapping of categories to attributes for the non-deterministic search system and enables the non-deterministic search system.

13. The computer-implemented system of claim 8, wherein the processor further receives a second search query that was also input to a non-deterministic search system, wherein the second search query is the same as the search query,
determines categories that are responsive to the second search query by reading the categories that were responsive to the search query from a cache storage;
receives second search results that were generated by the non-deterministic search system in response to the second search query and comprising items from the catalog;
determines categories of the items of the second search results;
determines a second query score for the non-deterministic search system based on the attributes and values for the categories that were determined to be responsive to the second search query and the categories of the items of the second search results;
determines that the second query score is below a threshold; and
disables the non-deterministic search system.

14. The computer-implemented system of claim 8, wherein the non-deterministic search system comprises a large language model.

15. A system comprising: one or more computers and one or more non-transitory storage devices storing instructions which are operable, when executed by the one or more computers, to cause the one or more computers to perform operations comprising:
receiving, at a computing device, a catalog comprising items;
determining, with the computing device, categories, attributes for the categories, and values for the attributes, from the items in the catalog;
receiving, with the computing device, a search query that was also input to a non-deterministic search system;
determining, with the computing device, categories that are responsive to the search query;
receiving, with the computing device, search results that were generated by the non-deterministic search system in response to the search query and comprising items from the catalog;
determining, with the computing device, categories of the items of the search results;
determining, with the computing device, a query score for the non-deterministic search system based on the attributes and values for the categories that were determined to be responsive to the search query and the categories of the items of the search results;
determining, with the computing device, that the query score is below a threshold; and
disabling, with the computing device, the non-deterministic search system.

16. The system of claim 15, wherein the instructions are operable, when executed by the one or more computers, to further cause the one or more computers to perform operations comprising
determining a recall metric for the non-deterministic search system based on the categories that were determined to be responsive to the search query and the categories of the items of the search results.

17. The system of claim 15, wherein the instructions which are operable, when executed by the one or more computers, to cause the one or more computers to perform operations comprising determining a query score for the non-deterministic search system based on the attributes and values for the categories that were determined to be responsive to the search query and the categories of the items of the search results further cause the one or more computers to perform operations comprising determining values and weights for attributes of the categories of the items of the search.

18. The system of claim 15, wherein the instructions are operable, when executed by the one or more computers, to further cause the one or more computers to perform operations comprising storing, in a cache storage, the categories, the attributes for the categories, the values for the attributes, the categories of the items of the search results, and values for attributes of the categories of the items in the search results.

19. The system of claim 15, wherein the instructions are operable, when executed by the one or more computers, to further cause the one or more computers to perform operations comprising:
updating a mapping of categories to attributes for the non-deterministic search system; and
enabling the non-deterministic search system.

20. The system of claim 15, wherein the instructions are operable, when executed by the one or more computers, to further cause the one or more computers to perform operations comprising:
receiving a second search query that was also input to a non-deterministic search system, wherein the second search query is the same as the search query;
determining categories that are responsive to the second search query by reading the categories that were responsive to the search query from a cache storage;
receiving second search results that were generated by the non-deterministic search system in response to the second search query and comprising items from the catalog;
determining categories of the items of the second search results;
determining a second query score for the non-deterministic search system based on the attributes and values for the categories that were determined to be responsive to the second search query and the categories of the items of the second search results;
determining that the second query score is below a threshold; and
disabling the non-deterministic search system.
